(19) United States
(12) Patent Application Publication
(10) Pub. No.: US 2021/0262570 A1
(43) Pub. Date: Aug. 26, 2021

(54) UNIVERSAL GASKET

(71) Applicant: Lavelle Industries, Inc., Burlington, WI (US)

(72) Inventor: Glenn W. Brown, Frankliln, WI (US)

(73) Assignee: Lavelle Industries, Inc., Burlington, WI (US)

(21) Appl. No.: 17/180,386

(22) Filed: Feb. 19, 2021

Related U.S. Application Data
(60) Provisional application No. 62/978,875, filed on Feb. 20, 2020.

(51) Int. Cl. F16J 15/08

(52) U.S. Cl. CPC F16J 15/0818

(57) ABSTRACT

A universal gasket includes a top surface having an outer diameter and an inner diameter and a bottom surface having an outer diameter and an inner diameter. A sidewall couples the top surface to the bottom surface, with a chamfer providing a decrease in diameter between the top surface and the bottom surface. The universal gasket is disposed between a water tank and a toilet bowl, providing a connection and seal between the water tank and a throat opening in the toilet bowl.

### PRIORITY CLAIM

This application claims priority to U.S. Provisional Patent Application No. 62/978,875, filed Feb. 20, 2020, the contents of which are hereby incorporated by reference.

### BACKGROUND

When installing toilets, a number of gaskets are used at various points within the toilet system. One location where a gasket is critical is between the toilet bowl and the toilet tank. This gasket may serve as the foundation of the tank when the tank is mounted to the toilet bowl; as a result, it is crucial that the gasket fit properly and be the correct size and type of gasket for the toilet tank and toilet bowl into which it is installed.

### BRIEF DESCRIPTION OF THE DRAWINGS

FIG. 1 is an example system including a universal gasket consistent with the present disclosure.

FIG. 2 is an example universal gasket consistent with the present disclosure.

FIG. 3 is an example system including a universal gasket consistent with the present disclosure.

FIG. 4 is another example system including a universal gasket consistent with the present disclosure.

FIG. 5 is another example system including a universal gasket consistent with the present disclosure.

FIG. 6 is another example system including a universal gasket consistent with the present disclosure.

### DETAILED DESCRIPTION

Conventional gravity-flush toilets are made up of several basic components. The two primary external components, generally made of porcelain or china, include a toilet bowl and a water tank. The water tank may be manufactured separately from the toilet bowl and attached, using bolts, to the toilet bowl, forming what is known as a two-piece toilet. In other examples, the toilet bowl and water tank may be manufactured as a single and continuous piece; this is known as a one-piece toilet.

When dealing with a two-piece toilet, the water tank is mounted to the toilet bowl at a plurality of mounting holes. The toilet bowl further includes an opening, known as a throat, which corresponds to an opening within the water tank. The throat allows water to pass from the tank into the toilet bowl when the toilet is flushed; thus, it is important to ensure that the opening in the water tank lines up with the throat.

Relatedly, it is also important to provide a seal between the toilet bowl and the water tank. This seal is generally implemented and provided at the nexus between the throat and the opening in the water tank, and involves the use of a gasket to seal the two components of the toilet. This gasket is important for multiple reasons; not only does it provide a seal between the toilet bowl and the water tank, it also helps seal the throat so that water does not escape from the water tank and leak outside the toilet when the toilet is flushed. The gasket is generally made of a compressible material, such as foam, plastic, or any other suitable material.

Due to the multi-functional aspect of the gasket, having a properly fitting gasket is crucial. However, actually selecting the correct gasket is complicated by a number of factors, including design features of the toilet bowl in question.

First, many two-piece toilets utilize stand-offs located on the toilet bowl. As used herein, a stand-off refers to a raised portion of a toilet bowl, generally located near the throat. Stand-offs provide a secure shelf for the tank to rest on once the tank is mounted to the toilet bowl. However, the size of the stand-offs varies widely, although they can generally be grouped into “short” (less than 0.5 inches), “tall” (greater than 0.5 inches), and no stand-off. The size of the stand-off helps dictate the size of gasket to be used when attaching the water tank to the toilet bowl; short gaskets are used with short stand-offs or with no stand-offs, while tall gaskets are used with tall stand-offs.

Incorrect gasket and stand-off pairings present multiple problems. When a short gasket is used in a toilet with a tall stand-off, the gasket will not compress, due to the difference in height. By not compressing, the gasket fails to seal the connection between the water tank and toilet bowl, creating a leak path. And, when a tall gasket is used in a toilet with a short stand-off or no stand-off, the tank sits too high. This causes instability and wobbling, and may lead to leaking of the water from the water tank. In addition, because the water tank is mounted to the toilet bowl using bolts, the height difference between the tall gasket and the short stand-offs may result in an installer over-torqueing the bolts, putting undue stress on the mounting system.

The size of the throat provides a second complicating factor. Toilet bowls are manufactured with a wide variety of throat diameters, ranging from an inch or less to over three inches in diameter. With such a varied range of diameters, it is not uncommon to have a gasket that risks slipping into the throat. This problem occurs most often when there is not a sufficient amount of interference between the outer diameter of the gasket and the throat; in other words, when there is not enough of the gasket resting outside the throat, on the toilet bowl. In addition, if the water tank is not installed so that it is directly centered over the throat, or if the gasket is made of a particularly soft material, the chances of the gasket slipping into the throat are increased. If the gasket slips into the throat, the seal between the water tank and the toilet bowl is compromised, leading to leaks.

A third complicating factor is whether the toilet bowl includes rim wash ports. A rim wash port refers to an opening within the throat through which additional water can flow from the water tank. Rim wash ports are used in some toilets to “wash down” the toilet bowl, particularly the bowl rim, after use; therefore, it is important that the rim wash ports are not blocked. Often, a toilet bowl that includes rim wash ports will have no stand-off but will instead rely on an additional mounting bolt to secure the water tank to the toilet bowl. Due to the lack of stand-off, finding a properly fitting gasket can be tricky. Short gaskets may allow the toilet's flush valve to sink too low into the throat, blocking the rim wash ports and rendering them useless. A tall gasket addresses the flush valve sinking problem but causes the water tank to sit too high and be unstable.

A universal gasket consistent with the present disclosure, by contrast, is designed to work with short and tall stand-offs or no stand-offs, as well as with smaller and larger throat diameters and with toilets with and without rim wash ports. The universal gasket of the present disclosure has a particular height that is tall enough to properly seal onto a toilet with tall stand-offs but is made with a geometry and a material that allows substantial compression for use on toilets with short stand-offs or no stand-offs. In addition, the universal gasket of the present disclosure has a greater outer diameter to accommodate varying throat diameters; this outer diameter also provides sufficient margin of error in installation such that if the water tank is not installed perfectly centered over the throat, the gasket does not risk slipping into the throat. Finally, a flat on the bottom of the universal gasket helps prevent blockage of rim wash ports in toilets that contain them, while the diameter and thickness of the gasket aid in positioning of the water tank such that components of the water tank will not be “compressed” into the throat, blocking the rim wash ports.

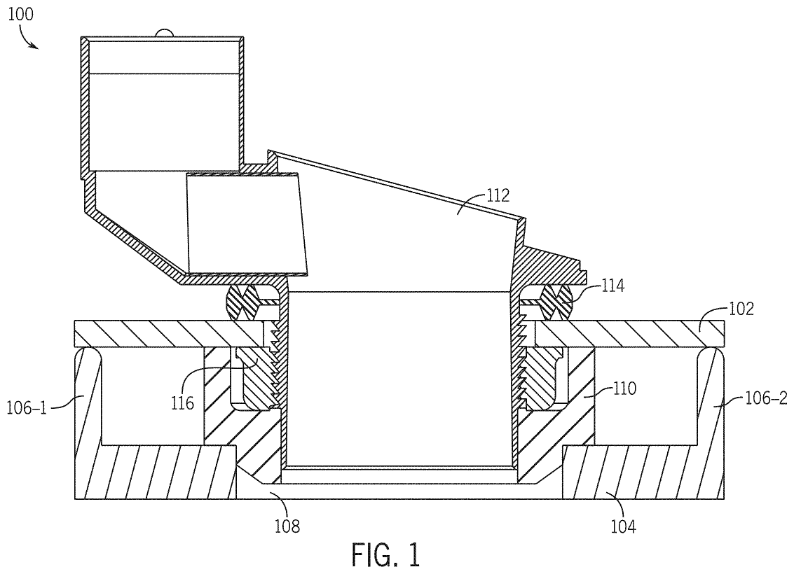

FIG. 1 is an example system 100 including a universal gasket 110 consistent with the present disclosure. System 100 includes a water tank 102 and a toilet bowl 104. Toilet bowl 104 includes a plurality of stand-offs 106-1, 106-2 (collectively, stand-offs 106). Although FIG. 1 shows stand-offs 106 as being on each side of toilet bowl 104, it is important to note that FIG. 1 shows system 100 in cut-away, and that stand-offs 106 extend around the toilet bowl 104. A throat 108 is disposed within toilet bowl 104.

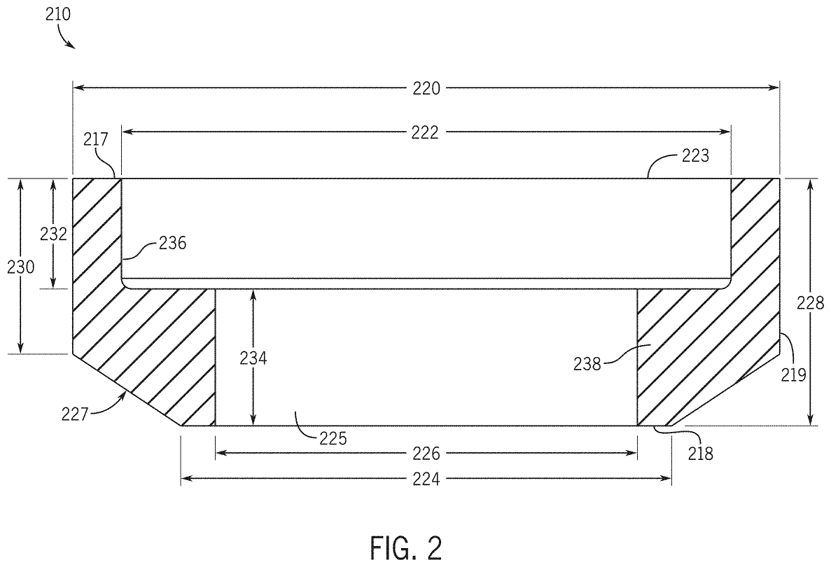

Gasket 110 is disposed between bowl 104 and tank 102; gasket 110 is discussed further herein with respect to FIG. 2. Extending into gasket 110 is flush valve 112. As used herein, a flush valve refers to a component located inside a toilet tank, such as tank 102, that moves the water from the toilet tank into the toilet bowl when the toilet is flushed. A flush valve seal 114 is disposed between flush valve 112 and tank 102. As used herein, a flush valve seal refers to a seal that serves to both properly space the flush valve from the water tank and to seal the opening in the tank through which the flush valve passes. Flush valve 112 is coupled to tank 102 by means of a flush valve nut 116. As shown in FIG. 1, flush valve nut 116 is disposed on the side of the tank 102 opposite the flush valve seal. Said differently, flush valve nut 116 secures flush valve 112 to the tank 102 at a location closer to the toilet bowl 104.

FIG. 2 is an example universal gasket 210 consistent with the present disclosure. Gasket 210 includes an upper surface 217, a lower surface 218, and a sidewall 219 disposed between the upper surface 217 and the lower surface 218 such that sidewall 219 connects upper surface 217 and lower surface 218. It is important to note that FIG. 2 shows gasket 210 in cut-away such that the internal structure is able to be seen; in practice, sidewall 219 is continuous. Gasket 210 may be made of foam, including open-cell foam, closed-cell foam, or a hybrid open/closed cell foam for compressibility, plastic, rubber, or any other suitable material.

Upper surface 217 of gasket 210 has an upper outer diameter 220 and an upper inner diameter 222. Upper outer diameter 220 extends from the outer edge of sidewall 219 across gasket 210 to the outer edge of sidewall 219 disposed directly opposite. Upper inner diameter 222, by contrast, is measured between the inner edges of sidewall 219, across a top opening 223 of gasket 210. As a result, upper inner diameter 222 is smaller than upper outer diameter 220. The specific difference between the upper outer diameter 220 and the upper inner diameter 222 may vary based on the dimensions of the material used to make gasket 210, the manufacturing of gasket 210, and other design considerations.

Similarly, lower surface 218 of gasket 210 has a lower outer diameter 224 and a lower inner diameter 226. As shown in FIG. 2, lower outer diameter 224 is smaller than upper outer diameter 220 of the upper surface 217, making lower surface 218 smaller than upper surface 217. As previously described, upper surface 217 and lower surface 218 are connected at sidewall 219. To account for the differences in diameter between the upper surface 217 and the lower surface 218, sidewall 219 includes a chamfer 227. As used herein, a chamfer refers to a transitional edge disposed between two faces of an object. In the present case, chamfer 227 is disposed between side wall 219 and lower surface 218.

The lower outer diameter 224 of lower surface 218 is measured with respect to the location of the chamfer 227. That is, the lower outer diameter 224 of lower surface 218 is measured from edge to edge of chamfer 227. The lower inner diameter 226 of lower surface 218, meanwhile, is measured with respect to an inner sidewall 238 of gasket 210 and corresponds to the diameter of a lower opening 225 of gasket 210. As with the upper outer diameter 220 and upper inner diameter 222 of upper surface 217, lower outer diameter 224 of lower surface 218 is greater than lower inner diameter 226 of lower surface 218, with the specific difference between the diameters depending on the diameter of lower opening 225, the thickness and width of the material used to make gasket 210, and other design considerations.

Gasket 210 has an overall height 228 that is sufficient for use on a toilet with tall stand-offs. Sidewall 219 has a height 230, which is measured from top surface 217 to the beginning of chamfer 227. Height 230 is less than overall height 228, as shown in FIG. 2.

Gasket 210 is further divided into an upper portion and a lower portion. The upper portion has a height 232 and, as described previously, has an outer diameter 220 and an inner diameter 222. The upper portion further includes an upper inner sidewall 236 disposed circumferentially around the inner portion of gasket 210, forming upper opening 223.

The lower portion has a height 234, an outer diameter 224, and an inner diameter 226. The lower portion also has a lower inner sidewall 238, disposed circumferentially to form lower opening 225. As shown in FIG. 2 and described previously, opening 225 may be smaller than opening 223. When disposed in a toilet, such as in system 100 (discussed with respect to FIG. 1), opening 225 may be inserted into the throat opening, while opening 223 may be coupled to the water tank.

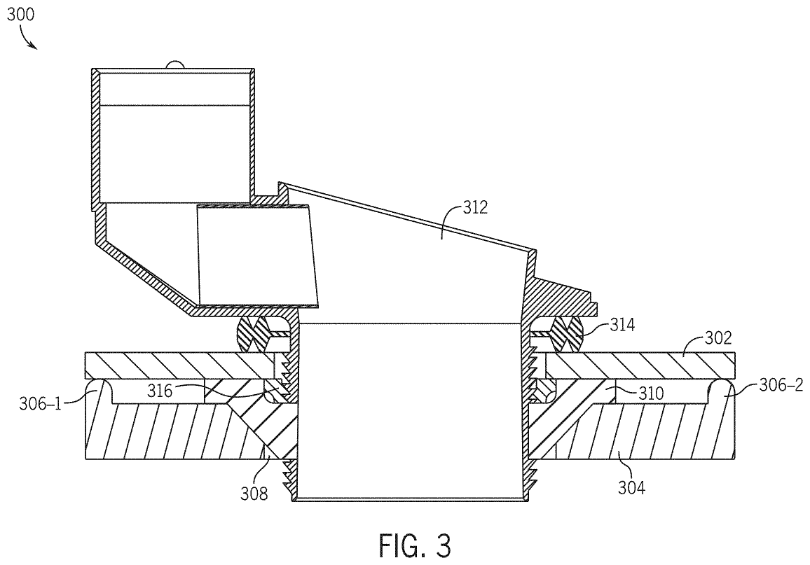

FIG. 3 is an example system 300 including a universal gasket 310 consistent with the present disclosure. System 300 includes a water tank 302 and a toilet bowl 304. Water tank 302 and toilet bowl 304 may be akin to water tank 102 and toilet bowl 104, discussed with respect to FIG. 1.

Toilet bowl 304 may include a plurality of stand-offs 306-1, 306-2 (collectively, stand-offs 306). Stand-offs 306 may be akin to stand-offs 106, discussed with respect to FIG. 1. In the case of system 300, stand-offs 306 may be short stand-offs, or stand-offs with a height less than 0.5 inches. As described previously, short stand-offs, such as stand-offs 306, require use of a shorter, or more compressed, gasket when installing water tank 302 to toilet bowl 304 in order to avoid instability or leaking. Toilet bowl 304 may further include a throat 308. Throat 308 may be akin to throat 108, discussed with respect to FIG. 1.

System 300 further includes a gasket 310. Gasket 310 may be akin to gasket 110 and gasket 210, discussed with respect to FIGS. 1 and 2, respectively. As shown in FIG. 3, gasket 310 may be disposed between water tank 302 and toilet bowl 304, providing a seal between the two components. Gasket 310 may be made of an open-cell foam material, allowing for sufficient compression in view of the height of stand-offs 306. Examples are not so limited, however, and gasket 310 may be made of any other material that allows suitable and sufficient compression. In addition, the specific geometry of gasket 310 may further contribute to the compressibility of gasket 310, particularly when a toilet bowl such as toilet bowl 304 has short stand-offs, such as stand-offs 306.

When installed, gasket 310 may be compressible between and by the water tank 302 and the toilet bowl 304. More particularly, gasket 310 may be installed such that the upper portion of gasket 310 is compressible by the water tank 302 of the toilet. The lower portion of gasket 310 is then compressible by a lower portion of the toilet, such as the toilet bowl 304.

System 300 may further include a flush valve 312. Flush valve 312 may be akin to flush valve 112, discussed with respect to FIG. 1. A flush valve seal 314 is disposed between flush valve 312 and tank 302; flush valve seal 314 may be akin to flush valve seal 114, discussed with respect to FIG. 1. As described previously, flush valve seal 314 serves the dual purpose of spacing flush valve 312 from water tank 302 and sealing the opening in water tank 302 through which flush valve 312 passes. Flush valve seal 314 is coupled to flush valve 312 at a flush valve nut 316. Flush valve nut 316 may be akin to flush valve nut 116, discussed with respect to FIG. 1.

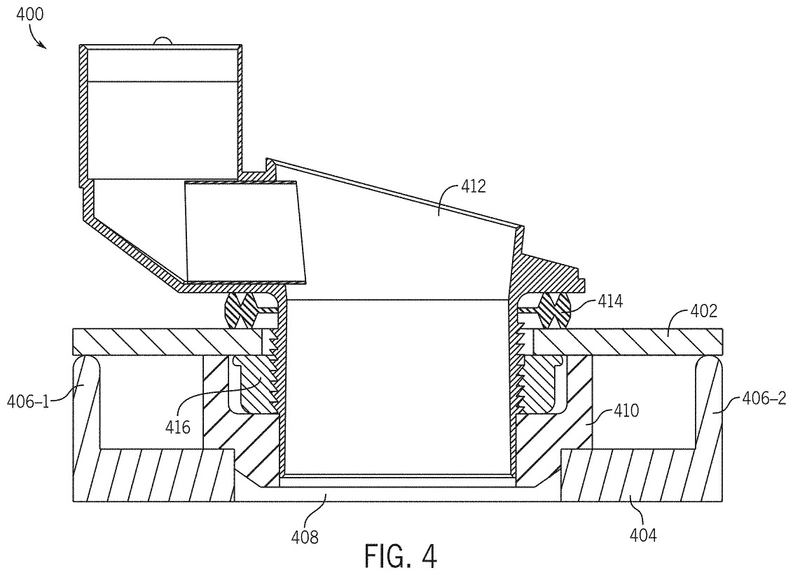

FIG. 4 is another example system 400 including a universal gasket 410 consistent with the present disclosure. System 400 may include a water tank 402 and a toilet bowl 404. Toilet bowl 404 may further include a plurality of stand-offs 406-1, 406-2 (collectively, stand-offs 406). With respect to system 400, stand-offs 406 may be tall stand-offs, or stand-offs having a height of 0.5 inches or greater. As previously discussed, tall stand-offs require the use of a taller gasket in order to properly seal the connection point between the water tank and toilet bowl. In addition, toilet bowl 404 may include a throat 408.

System 400 may further include a gasket 410. Gasket 410 may be akin to gaskets 110, 210, 310, discussed with respect to FIGS. 1-3, respectively. More particularly, gasket 410 may be identical to gasket 310, whose use in a system with short stand-offs was discussed with respect to FIG. 3. Although stand-offs 406 have a height greater than the height of stand-offs 306, gasket 410 is a universal gasket, meaning that it works for both system 300 (with short stand-offs) and system 400 (with tall stand-offs). Although gasket 410 may be made of an open cell foam material for compressibility, its overall height (height 228, discussed with respect to FIG. 2) is sufficient to allow full sealing when tall stand-offs are present. In addition, gasket 410 may be made of a closed cell foam or a hybrid open/closed cell foam, or any other suitable material.

A flush valve 412 may extend through an opening in water tank 402, and may be sealed and spaced through use of a flush valve seal 414. Flush valve 412 and flush valve seal 414 may be akin to flush valves 112, 312 and flush valve seal 414 may be akin to flush valve seals 114, 314, discussed with respect to FIGS. 1 and 3, respectively. Flush valve 412 may further be coupled to flush valve nut 416, with flush valve nut 416 holding flush valve 412 in place.

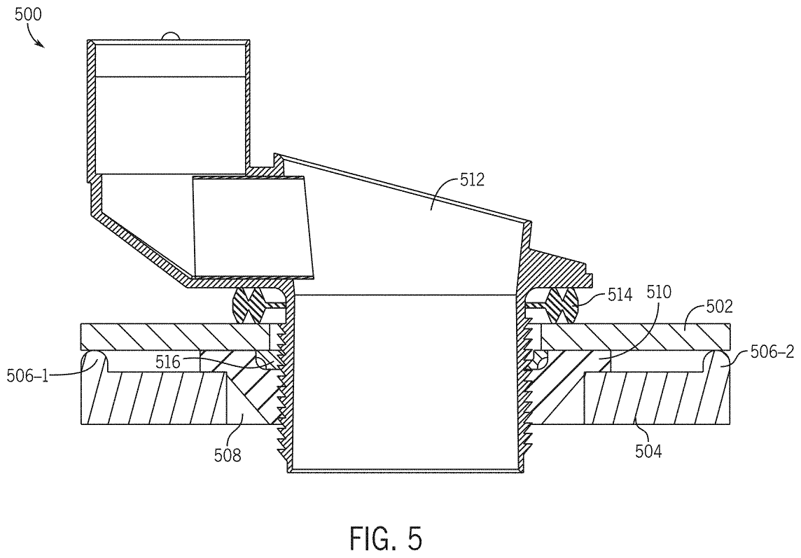

FIG. 5 is another example system 500 including a universal gasket 510 consistent with the present disclosure. System 500 includes a water tank 502, a toilet bowl 504, and a plurality of stand-offs 506-1, 506-2 (collectively, stand-offs 506). Stand-offs 506 are shown as short stand-offs; however, examples are not so limited and stand-offs 506 may be tall stand-offs.

Toilet bowl 504 may further include a throat 508. A throat refers to an opening in the toilet bowl through which water can pass from the water tank into the bowl when the toilet is flushed. As described previously, the diameter of the throat can vary greatly, which can present issues when trying to place a gasket and seal the water tank to the toilet bowl. Throat 508 represents a throat having a greater than normal diameter, meaning that, with an ordinary gasket, a user runs the risk of the gasket slipping into the throat and not properly sealing.

System 500 includes a universal gasket 510. As shown in FIG. 5, gasket 510 is disposed between the water tank 502 and the toilet bowl 504, with a lower portion of gasket 510 extending into the throat 508. The upper diameter of gasket 510 (diameter 220, discussed with respect to FIG. 2) is large enough that gasket 510 is able to be placed and have sufficient overlap on the edges to sit on toilet bowl 504 outside throat 508. That is, the diameter of gasket 510 is sufficiently great so as to accommodate a throat having a larger diameter, such as throat 508, by providing adequate interference between the gasket 510 and the toilet bowl 504. In addition, as discussed previously, the increased outer diameter of gasket 510 provides an additional margin of error for installation of the water tank 502 onto the toilet bowl 504, while still sealing the opening and preventing leaks.

A flush valve 512 may extend through an opening in water tank 502. Flush valve 512 may be akin to flush valves 112, 312, and 412, discussed with respect to FIGS. 1, 3, and 4, respectively. Flush valve 512 may be sealed and spaced through use of a flush valve seal 514; flush valve seal 514 may be akin to flush valve seals 114, 314, and 414, discussed with respect to FIGS. 1, 3, and 4 respectively. Flush valve 512 may further be coupled to flush valve nut 516, with flush valve nut 516 holding flush valve 512 in place.

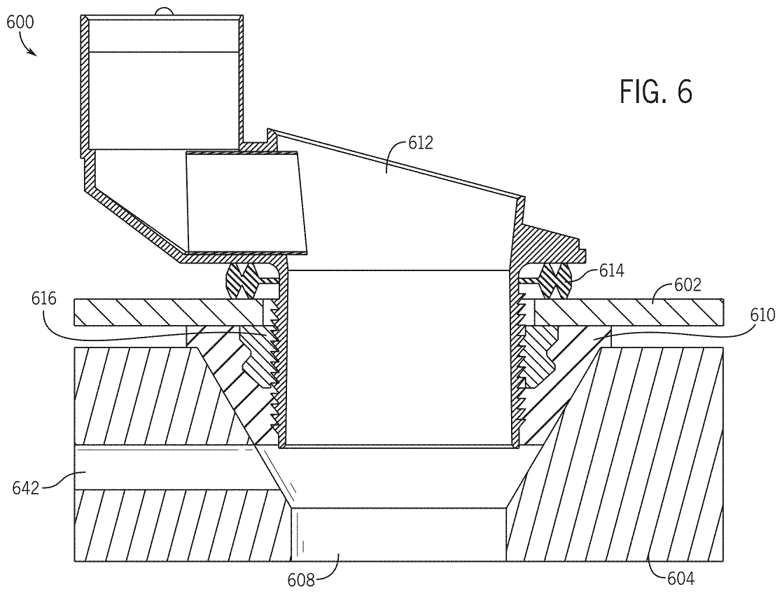

FIG. 6 is another example system 600 including a universal gasket 610 consistent with the present disclosure. System 600 includes a water tank 602 and a toilet bowl 604 having a throat 608. However, system 600 does not include any stand-offs; instead, water tank 602 is coupled directly to toilet bowl at a gasket 610. System 600 does, however, include a rim wash port 642. As previously discussed, a rim wash port refers to an opening within the throat through which additional water can flow from the water tank; they are used in some toilets to “wash down” the toilet bowl, particularly the bowl rim, after use.

Gasket 610 includes a flat on the bottom thereof (shown in FIG. 2) such that, when gasket 610 is placed between water tank 602 and toilet bowl 604, gasket 610 avoids blocking rim wash port 642. In addition, as described with respect to FIG. 5, gasket 610 has a greater diameter than traditional gaskets. When combined with an increased thickness, gasket 610 further helps prevent blockage of rim wash port 642 by causing water tank 602 to sit slightly higher with respect to toilet bowl 604, although not so high that water tank 602 is unstable. In addition, the watertight seal between water tank 602 and toilet bowl 604 is retained, as gasket 610 has a sufficient height to provide a connection between the two components.

A flush valve 612 may extend through an opening in water tank 602. Flush valve 512 may be akin to flush valves 112, 312, 412, and 512, discussed with respect to FIGS. 1, 3, 4, and 5 respectively. Importantly, flush valve 612 does not extend far enough into throat 608 to block rim wash port 642. This is due to the height and geometry of gasket 610, described previously.

Flush valve 612 may be sealed and spaced through use of a flush valve seal 614. Flush valve seal 614 may be akin to flush valve seals 114, 314, 414, and 514, discussed with respect to FIGS. 1, 3, 4, and 5 respectively. Flush valve 612 may further be coupled to flush valve nut 616, with flush valve nut 616 holding flush valve 612 in place.

In the foregoing detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure. It is to be understood that other examples may be utilized and that changes may be made without departing from the scope of the present disclosure.

The figures herein follow a numbering convention in which the first digit corresponds to the drawing figure number and the remaining digits identify an element or component in the drawing. Like digits should be taken to identify like drawings, with the different first digits corresponding to the drawing figure. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure and should not be taken in a limiting sense.

1. A toilet gasket, comprising:
an upper surface, the upper surface further comprising:
an upper outer diameter; and
an upper inner diameter;
a lower surface, the lower surface further comprising:
a lower outer diameter; and
a lower inner diameter;
a sidewall disposed between and connecting the upper surface and the lower surface; and
an opening extending through the gasket, wherein the opening is bounded by the sidewall, the upper surface, and the lower surface.

2. The toilet gasket of claim 1, wherein:
the upper outer diameter extends from a first upper outer edge of the sidewall to a second upper outer edge of the sidewall disposed directly across from the first upper outer edge of the sidewall;
the upper inner diameter extends from a first upper inner edge of the sidewall to a second upper inner edge of the sidewall such that the upper inner diameter extends across the opening; and
the upper outer diameter is greater than the upper inner diameter.

3. The toilet gasket of claim 1, wherein:
the lower outer diameter extends from a first lower outer edge of the sidewall to a second lower outer edge of the sidewall disposed directly across from the first upper outer edge of the sidewall;
the lower inner diameter extends from a first upper inner edge of the sidewall to a second lower inner edge of the sidewall such that the lower inner diameter extends across the opening;
the lower outer diameter is greater than the lower inner diameter; and
the upper inner diameter is greater than the lower outer diameter.

4. The toilet gasket of claim 1, wherein the side wall further comprises a chamfer disposed between the sidewall and the lower surface.

5. The toilet gasket of claim 1, wherein the gasket is compressible such that the gasket compresses when installed between a water tank of a toilet and a toilet bowl in a toilet system.

6. The toilet gasket of claim 5, wherein:
the gasket is made of a compressible material; and
the compressible material allows the gasket to be compressed to varying degrees such that the gasket may be used with a variety of toilet stand-off heights.

7. A toilet gasket, comprising:
an upper portion, the upper portion further comprising:
a top surface;
an upper height;
an upper outer portion having an upper outer diameter;
an upper inner portion having an upper inner diameter; and
an upper inner sidewall disposed circumferentially about the upper inner portion to form an upper opening;
a lower portion, the lower portion further comprising:
a bottom surface;
a lower height;
a lower outer portion having a lower outer diameter;
a lower inner portion having a lower inner diameter; and
a lower inner sidewall disposed circumferentially about the lower inner portion to form a lower opening; and
an outer sidewall, wherein:
the outer sidewall is disposed between and connects the upper portion and the lower portion;
the outer sidewall includes a chamfer; and
the outer sidewall has a height, wherein the outer sidewall height is measured between the top surface and the beginning of the chamfer.

8. The toilet gasket of claim 7, further comprising a total height, wherein:
the total height comprises the upper height plus the lower height; and
the total height is equal to or greater than a gasket height for a toilet having tall stand-offs.

9. The toilet gasket of claim 7, wherein the upper opening is larger than the lower opening.

10. The toilet gasket of claim 7, wherein:
the upper opening is sized to couple to a water tank of a toilet; and
the lower opening is sized to couple to a throat opening of the toilet.

11. The toilet gasket of claim 7, wherein:
the upper portion is compressible by a water tank of a toilet; and
the lower portion is compressible by a lower portion of the toilet.

12. The toilet gasket of claim 7, wherein the gasket is compressible between a water tank of a toilet and a toilet bowl.

13. The toilet gasket of claim 7, wherein the lower portion of the gasket further comprises a flat to prevent the gasket from blocking a rim wash port.
